(19) United States
(12) Patent Application Publication
(10) Pub. No.: US 2013/0006562 A1
(43) Pub. Date: Jan. 3, 2013

(54) QUALITY ASSURANCE SYSTEM FOR ELECTIONS

(75) Inventors: Gerald B. Feldkamp, Beaverton, OR (US); G. Scott Scholler, Poway, CA (US)

(73) Assignee: CCCOMPLETE, INC., Portland, OR (US)

(21) Appl. No.: 13/174,412

(22) Filed: Jun. 30, 2011

(51) Int. Cl. G06F 19/00

(52) U.S. Cl. 702/81

(57) ABSTRACT

A system is provided for improved quality assurance (QA) in remote-access elections by a QA unit that evaluates an election service provider (ESP) that tallies votes, each of which includes a vote-identification number (VIN) and a vote content. The QA unit assures a likelihood that no votes have been deleted, inserted or changed by the ESP. The QA unit does this by allocating QA VINs and voting QA votes and then checking the ESP's report of all VINs included in the tally and the content of all QA votes. The ESP, if unaware of which votes are QA votes and which are voter voters, is prevented from deleting, inserting, or changing votes without risk of detection by the check of the QA votes. The system includes capability of ensuring defined confidence levels for a given quantity of voters and an expected voter turnout by incorporation of a suitable number of QA VINs.

### BACKGROUND

An election system is disclosed for assuring the quality of an online voting process for receiving and tallying the contents of votes, where each vote content is paired with a valid, unique vote-identification number (VIN). The system detects fraud and errors by incorporating VINs that are reserved for quality assurance purposes. These reserved VINs may be cast with a known vote content or not cast at all in order to evaluate whether any votes in the online voting system have been deleted inserted, or changed. Such reserved votes are not used in the tally of the vote for the election, but they can be used to gauge the likelihood that any votes tallied as cast by actual voters have been the subject of any fraud or error in the online voting process.

In an election system used to provide voting by an established group, such as individuals in a member-based organization or by any population of registered voters, a data processing system may provide for communication with the voters. Typically, an election services provider (ESP) will use the data processing system to conduct the election on behalf of an organization that is having the election, such as a union or a governmental entity.

Electronic communication by the data processing system may use wireless or land-based (wired) telephone systems and/or computer systems, including local or wide-area networks, such as the Internet and world-wide web. The voters, the ESP, and the organization will each have specified access to the data processing system to carry out the election. An example of such a system is described in U.S. Pat. No. 7,597,258 and a diagram of such an election system is shown in FIG. 1.

Votes may be cast (principally) by telephone and Internet in remote-access elections. As this is a relatively new way of conducting elections, concerns about the possibility of votes being altered in the data processing systems may not be addressed by existing methods of ensuring the integrity of election processes. Mishandling by the election service provider of vote data—either intentionally or errantly—can affect the outcome of an election. Furthermore, absence of knowledge about the likelihood that such mishandling may have occurred undermines trust in the validity of the remote-access election.

Existing electronic voting methods may provide audit trails for detecting fraud and other abuses of the voting system. One such audit trail incorporates tracking of a vote identifier and the content of that vote while not allowing any single individual to link a voter's identity and her vote. However, such tracking may still be susceptible to fraud or error if the ESP can delete or otherwise remove from the tally any valid votes, insert or otherwise add improper votes to the tally, or change the contents of votes.

### BRIEF SUMMARY

An election system is disclosed with a quality assurance design capable of detecting added, changed, and/or deleted votes without the necessity of associating the content of the vote with any individual voter. The system may also provide a statistical level of confidence in the quality assurance. Even where the level of confidence is less than 100%, any attempts at fraud may be deterred by the likelihood of detection.

The election system may provide a method for a quality assurance (QA) unit to evaluate a quality of an election conducted by an election service provider (ESP) for an organization. A confidence level may be specified by the organization and processed in a QA computer to determine how many votes, beyond the number of voters, to incorporate for quality assurance purposes. The QA computer then requests and receives from the ESP's computer a set of vote-identification numbers (VINs) sufficient in number to provide for the voters' votes and for the quality assurance votes. Then, in a voting period, the QA computer votes the QA votes, typically via the same route as the voting by the actual voters. Preferably, the QA votes are indistinguishable in all respects from the point of view of the ESP computer from the votes of the actual voters. Typically the QA computer will cast some, but not all, of the QA votes, maintaining a record of which were cast and with what vote content. Generally some time after the voting period has concluded, the ESP computer provides a tally of the votes and reports that back to the QA unit and/or the organization having the election.

In addition to the quality assurance usage, the QA computer's record of QA VINs and vote contents may be retained to correct the tally of votes to reflect only votes by actual voters. That is, since the ESP preferably cannot distinguish between QA votes and actual voter votes, the tally will reflect the total for all and the QA votes will need to be subtracted from the tally.

After the voting period, the QA computer receives from the ESP computer system a list of all VINs in the plurality of received votes and compares those VINs to the QA VINs voted during the voting period. Any missing or added QA VINs are the result of fraud or error and indicate a problem with the election provider's operations. If all voted QA VINs are present, and no non-voted QA VINs are present, then the QA computer may calculate and/or report a likelihood or confidence level that no votes have been deleted or added in the votes cast by actual voters.

The QA computer may further evaluate a likelihood that no actual votes have been changed by the ESP by checking the vote content of the QA votes. Preferably, after the voting period, the QA computer transmits the voted QA VINs to the ESP computer system. This may be done after the ESP computer has already reported all voted VINs and the tally to the QA computer, so that the voted QA VINs may not be used by the ESP computer to distinguish between QA and actual votes.

The ESP computer system transmits to the QA computer the vote content for each voted QA VIN and the QA computer checks for any changed vote content by comparing its and the ESP computer's record of the vote content for each voted QA VIN. If votes are changed, the ESP computer may be suspected. If no votes are changed, then the QA computer may determine and report on the likelihood that no actual voters' votes were changed by the ESP.

### BRIEF DESCRIPTION OF THE DRAWINGS

FIG. 1 is a diagram showing an example of a prior art election system.

FIG. 2 is a diagram showing an example of an election system incorporating quality assurance voting.

FIG. 3 is a chart showing a spreadsheet with variables and quantities relating to an analysis of the probabilities for detection of added votes.

FIG. 4 is a chart showing a spreadsheet with variables and quantities relating to an analysis of the probabilities for detection of deleted or changed votes.

### DETAILED DESCRIPTION OF VARIOUS EMBODIMENTS

In cases where the reputation and demonstrated trustworthiness of the election service provider is not sufficient to allay concerns about mishandling of vote data, a method of objectively measuring the voting system's performance may be useful. The method is applicable to remote-access elections conducted by many kinds of organizations, including trade unions, public governments, and federal agencies, and any circumstances in which one wants to evaluate the integrity of data submitted to a data processing system by a plurality of individuals without associating the content of that data with the identities of the individuals.

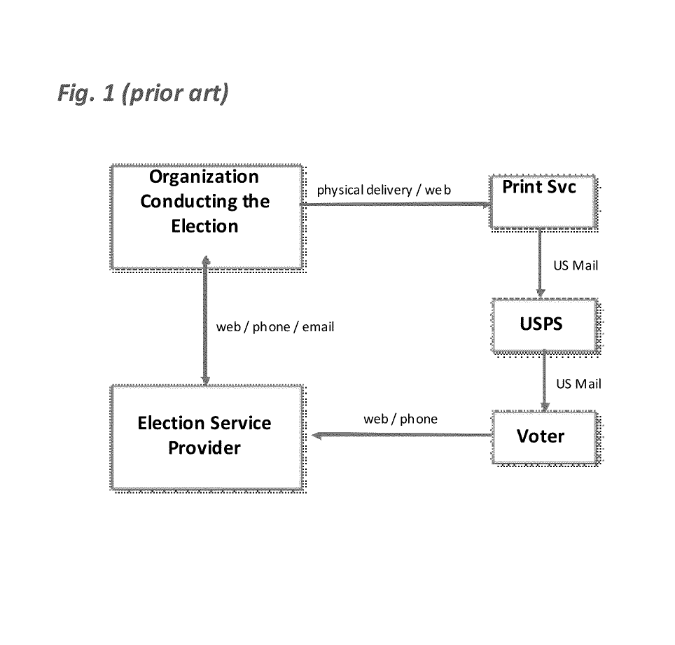

A block diagram showing typical communication paths between entities involved in a remote-access election is shown in FIG. 1. Typical features of this architecture include:
The Election Service Provider (ESP) and the organization having the election may be independent entities. The organization typically does not have direct physical or electronic access to the equipment, such as an election computer, held by the ESP.
Voters may identify themselves to the voting system maintained by the ESP using a unique, anonymous access code. Preferably this code is not conveyed to them directly from the ESP, although the voters may receive the code from any source and by any route suitable for the particular election. This code may be referred to as a vote-identification number (VIN). As shown in FIG. 1, an intermediate Printing and Mailing Service Provider (Print Svc) may receive documents and VINs from the organization and then print and mail the documents and VINs through the US Post Office or other suitable delivery methods. Alternatively, the organization may provide the VINs to the voters by any suitable route, direct or indirect.
For any given election, the organization may specify to the ESP the number of VINs that will be needed; the ESP may generate exactly that many, keeping a record of the VINs because the ESP will only accept and tally votes from valid VINs. The ESP delivers the VINs to the organization. The organization may then be responsible for assigning VINs to eligible voters and conveying the VINs to the voters.
Votes may be submitted by voters, e.g., via the Internet or phone, and stored in equipment held by the ESP, and tallies may be produced from these stored votes.
A used-VINs report may be produced by the ESP after the election; the report lists every VIN used to cast a vote in this election. One purpose for this is that the ESP and the organization can verify that only valid VINs were used in the election.

Without direct access to the ESP's equipment, the organization may use a remote method to provide a level of assurance that the tally accurately reflects the actual votes, without any votes being deleted, added or changed by the ESP. The method in an embodiment of the present disclosure may include allocating enough VINs, not only to assign a VIN to each eligible voter, but also to allocate a number of additional VINs that may be used for assuring the quality of this particular election. These additional VINs are not given to voters, but may instead be reserved as QA VINs for use by the organization itself or by a quality assurance (QA) unit acting on behalf of the organization. Alternatively or additionally, the QA unit may act on behalf of another entity that has an interest in assuring the quality of the election.

Votes cast using these QA VINs are preferably cast in the same manner as votes cast by actual voters. So, if the election system accepts actual votes through the telephone and/or Internet, then the QA votes can be cast in those ways. Preferably, the QA unit casts the votes so that the ESP equipment cannot, by any means, distinguish them from actual votes. In this manner, the election system may detect mishandling by the ESP, regardless of whether the errors are caused by bad engineering, faulty hardware, or intentional fraud. Irrespective of whether the election system can determine the source(s) of the problem, the method provides a route to reveal the existence of the problem and/or to gauge the likelihood that the problem exists. Typically the method will at least isolate the problem to the ESP.

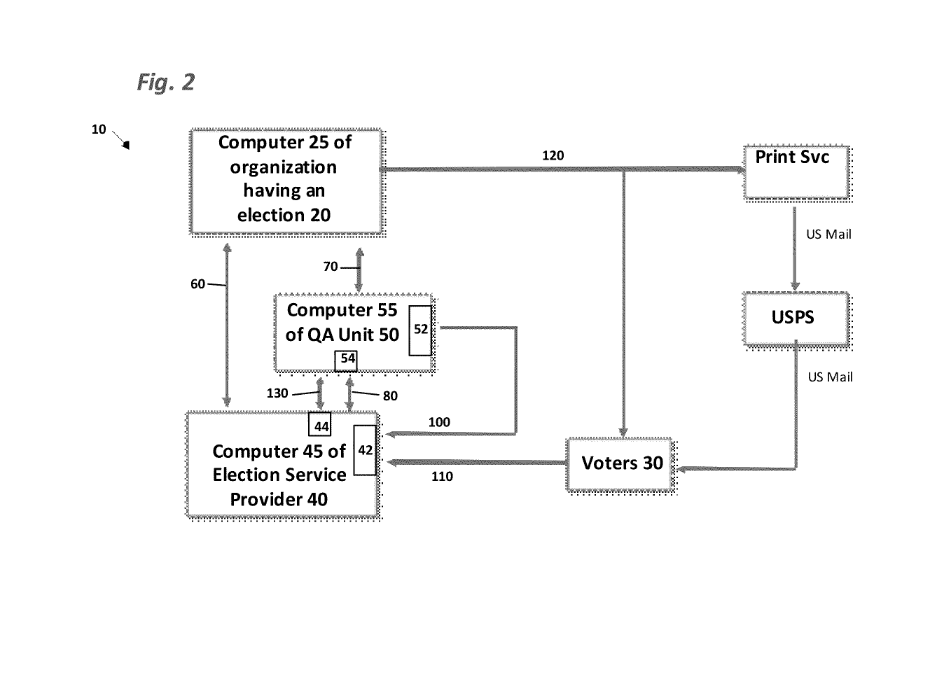

An example election system may provide communication among the computer systems of an election service provider (ESP), an organization having the election, and a group of voters. An example election system 10, depicted in FIG. 2, may include a computer system 25 of an organization 20 holding an election, a group of individuals 30 who are eligible to vote, a computer system 45 of an election service provider (ESP) 40, and a computer system 55 of a quality assurance (QA) unit 50.

Each computer system 25, 45, and 55 typically includes at least one computer configured with memory, a processor, and instructions and data stored in memory. The computer system(s) may be in communication with a local or wide-area network, using network communication protocols well-known in the art. Preferably, the organization's computer 25 is coupled to each of the ESP's computer 45 and to the QA unit's computer 55 by electronic communication links 60, 70, such as the Internet, including email, with suitable measures applied as necessary for security. The QA unit's computer 55 is similarly coupled to the ESP's computer via an electronic communication link 80. Communication may also be carried out among the organization, QA unit, and ESP, as suitable for carrying out the election system, e.g., by phone-to-computer interfaces.

A method for using election system 10 to assure the quality and integrity of an election may make use of QA unit 50, typically to check the accuracy of ESP 40. Other aspects of the election may also be monitored by QA unit 50.

QA unit 50 may evaluate multiple qualities of the election conducted by ESP 40 for organization 20. These qualities generally relate to whether ESP 40 has altered any votes, and other qualities may also be evaluated by QA unit 50. ESP 40 may be responsible for receiving votes from voters and providing a tally of those votes. Given that responsibility, ESP 40 may be a source for alteration of the votes and/or tally. QA unit 50 may detect whether ESP 40 has altered any vote, e.g., by deleting votes or otherwise removing any valid votes from the tally any valid votes, inserting or otherwise adding improper votes to the tally, or by changing the content of any vote.

Typically voters 30 are associated with the organization, such as by being members of a union or by being citizens within the jurisdiction of a governmental entity. Ordinarily the organization decides who are eligible voters for each election and maintains rolls or rosters identifying and maintaining the voters' identity and contact information.

The organization may have a legally imposed mandate, or may otherwise determine, a confidence level required for a particular election. Election system 10 may assure one or more qualities of the election to that confidence level. For example, the confidence level may be a measure of certainty that no fraud or errors have occurred in the election, such as, at the ESP. Organization 20 may specify the confidence level to QA unit 50, e.g., via link 70 or via other suitable means. The confidence level may be the level of assurance that no votes have been deleted, inserted, or changed and/or may be separately specified for one or more of such alterations.

ESP computer 45 is programmed for carrying out the election, including an interface 42 to electronic communication links 100, 110 by which ESP computer 45 is configured to receive a plurality of votes from the quality assurance unit and from the voters via the electronic communication links. Any suitable means for remote access may be used for links 100, 110, with interface 42 configured to accept such links. Preferably, interface 42 is not provide with any capability to distinguish between votes arriving via link 100 as opposed to link 110.

Generally, ESP computer 45 can receive votes only during a voting period, typically defined by the organization, although the QA unit, ESP, and/or a third party may have a role in defining the voting period. ESP computer 45 will ordinarily register a valid vote only where the vote includes a valid vote-identification number (VIN) and a valid vote content. ESP computer 45 may apply such suitable validation techniques as comparing the VIN to the list of VINs issued by the ESP computer and comparing the vote content to a list of acceptable possible votes.

An example of a voting process with an embodiment of the method of the present description may include the following steps, generally in the following order, although that may be modified as appropriate for a particular election:

1. QA computer 55 may receive from the organization a voter quantity, which the organization may have determined from its roster of voters. QA computer 55 may also receive the confidence level that the organization may specify for a quality, such as no fraud or errors in the tallying of the vote. These communications may occur via link 70 or by other suitable means;

2. QA computer 55 may determine an election quantity that is greater than the voter quantity, as will be described in more detail below;

3. QA computer 55 may request the election quantity of VINs from ESP computer system 45, e.g., via electronic communication link 80;

4. QA computer 55 may receive the election quantity of VINs from ESP computer system 45, e.g., via electronic communication link 80;

5. QA computer 55 may allocate as QA VINS a QA quantity of VINS from the election quantity of VINs. QA computer 55 may provide to the organization the voter quantity of VINs, which the organization may provide to voters 30 via an electronic communication link or other suitable means 120 (FIG. 2). Typically, the QA quantity of VINs is equal to the election quantity of VINs minus the voter quantity of VINs, although other allocations may be applied as suited to a particular election. QA computer 55 may allocate the QA quantity of VINs into a deletion-detection quantity of VINs and an insertion-detection quantity of VINs. Typically, the detection-deletion quantity is a to-be-voted quantity, and the insertion-detection quantity is a not-to-be-voted quantity;

6. During the voting period, actual voters may cast votes via link 110. Also during the voting period, QA computer 55 may cast votes via link 100. Preferably, QA computer 55 casts a portion of the QA VINs and alternatively may cast substantially all of the QA VINs, in either case using an output 52 of QA computer 55 that may allow QA votes to be indistinguishable from votes of actual voters. Preferably, QA computer 55 votes the deletion-detection quantity of VINs and QA computer 55 does not vote the insertion-detection quantity of VINs;

7. QA computer 55 may receive from ESP computer 45 a list of all VINs in the plurality of received votes. Preferably, this occurs after the end of the voting period;

8. QA computer 55 may compare the VINs in the plurality of received votes to the QA VINs that QA computer 55 voted during the voting period;

9. QA computer 55 may determine whether any fraud or errors are indicated by any discrepancy between the ESP's record of voted VINs and the voted QA VINs. Preferably, QA computer 55 reports whether any votes of the QA VINs were deleted by the ESP and whether any votes of the QA

VINs were inserted by the ESP. If no discrepancies appear, then QA computer 55 may determine a likelihood that no significant fraud or errors are present in the actual votes, and QA computer 55 may report this quality of the election to the organization 20;

10. The ESP 40 may provide a tally of valid votes to the organization 20 and/or the QA unit 50 by any suitable means. Additionally, the ESP 40 may provide a listing of the content of all valid votes to the organization 20 and/or the QA unit 50 by any suitable means. The QA unit 50 may provide for a correction to that tally to account for voted QA VINs; and

11. Preferably after the voting period and after the ESP's report of voted VINs and the vote tally, QA computer 55 may provide to ESP computer 45 a list of the QA VINs voted during the voting period. This list may be provided via an electronic communication link 130 to a tool 44 within ESP computer 45. Tool 44 and/or software in ESP computer 45 may control or limit how the QA VINs are used in ESP computer 45 to ensure integrity of the vote tally. QA computer 55 may receive from ESP computer 45 the vote content for each voted QA VIN. QA computer 55 may report whether any vote content was changed by the ESP.

Alternatively or additionally, the QA unit 50 may report to an entity independent of the organization 20 for whom the election was conducted on one or more qualities of the election. This may include the same qualities reported to the organization or other qualities.

An election evaluation system in accordance with an embodiment of the present disclosure may be used to evaluate the integrity of the election conducted by an ESP computer system 45. The election evaluation system may include QA computer 55 having a coupler 54 for interfacing via link 80 with the ESP computer system 45. QA computer 55 is preferably programmed to carry out the operations described herein. Such programming may be embodied on a storage medium readable by a processor within QA computer 55 and include a program of commands executable by the processor.

QA computer 55 may determine the election quantity of VINs by applying a quality factor to the quantity of voters. The quality factor may be calculated from the confidence level and may be expressed as a fraction or multiple. A spreadsheet may be used for calculation of the quality factor from the confidence level.

Any suitable means may be used to ensure that the QA computer's votes, which typically will be automated votes, are indistinguishable from votes of actual voters.

For simplicity, the remainder of this disclosure collectively refers to the various sources of discrepancies in voting as “fraud.” The likelihood or probability of detecting fraud may be derived as described below, along with methods of calculating what number of QA VINs may be incorporated to provide desired confidence levels or probabilities of fraud detection.

### Examples of Fraud and How to Detect

Fraud may occur in the following three ways:

Votes are added.

Votes are removed.

Votes are modified.

For the purpose of detecting fraud, the QA unit specifies a number of eligible voters greater than the number of actual people who are eligible to vote. The resulting excess VINs can be used by the QA unit to detect fraud with any selectable probability; these VINs preferably are not passed to the actual voters.

The fraud-detection issue may be viewed as the question of “How many QA VINs are to be created to detect that votes were added, removed, or modified in a remote-access election, for a selectable probability of detection?”

### General Model of VINs and Votes

For any election, it may be convenient to group all VINs into four categories:
A. VINs assigned to eligible voters, and that were used to cast a vote
B. VINs assigned to eligible voters, but that were not used to cast a vote
C. VINs assigned for QA use by the QA unit, and that were used to cast a QA vote
D. VINS assigned for QA use by the QA unit, but that were not used to cast a QA vote
   In the following sections, NA, NB, NC, and ND are used to denote the number of VINs in each category, respectively.

To detect added or inserted votes, the QA unit allocates some number of excess VINs which will not be used to cast QA votes in this election; these VINS belong to Category D. At closing, the QA unit requests a used-VINs report of all VINs used to cast votes. If any of these unused QA VINs appear in the list, then the ESP has mishandled the vote-data. Preferably, the ESP is unaware of which VINs the organization is using for QA, and which ones have been handed to eligible voters, and therefore the ESP will not be able to add votes from category B without running risk of detection.

An embodiment of the present disclosure may make use of this method by use of a formula that calculates how many such excess VINs to allocate to detect fraudulent addition of votes, at some selectable probability of detection. Probabilities herein are in the range 0 to 1. A probability of 0.8 is the same as saying the probability is 80%. A probability of 1 says the event is a certainty. The probability of some event occurring is understood to be equal to “one minus the probability of the event not occurring.”

A preferred way to calculate the probability of detecting fraudulent vote-additions is to find “one minus the probability of not detecting fraudulent vote-additions.” Identifying how such additions could be made without the QA unit detecting them can be accomplished as follows. Out of the four VIN-categories (A, B, C, and D, defined above), only a fraudulent vote-addition cast using one of the Category B VINs would not be detectable by the QA unit. (A and C are out, because these VINs are already used to vote, and D is out because the organization or QA unit would detect additions tied to the Category D VINs simply by examining the used-VINs report.)

So, whether by error or intention, the ESP can use NB out of (NB+ND) possible VINs to cast an undetectable, fraudulent vote. Therefore the probability of not detecting the addition of a single vote is:

P_{UNDET}(1)=NB/(NB+ND)

Example: Suppose NB and ND both equal 10. Then P_{UNDET}(1) is 10/(10+10), or 0.5. This means the ESP has a 50% chance of not getting caught adding a single vote. If more Category D VINS had been created, say 20, then P_{UNDET}(1) would be 10/30, or 0.33. One can drive down the probability of not detecting single fraudulent additions simply by creating more Category D VINs.

The probability of not detecting the addition of two votes can also be calculated. This event can be decomposed into: (1) not being detected on the first addition; and (2) not being detected on the second addition, given that the first addition was not detected. At the second addition, there are (NB−1) VINs we can use for the fraudulent vote, out of a possible (NB-1+ND) VINs. (The “1” is subtracted because the first event used up one of the B VINs.) The probability of a sequence of independent events may be computed by multiplying their individual probabilities. Therefore:

P_{UNDET}(2)=(NB/(NB+ND))*((NB−1)/(NB−1+ND))

so P_{UNDET}(2)=0.24 in the example with NB=ND=10. The probability of not detecting the fraud is going down as the number of additions increases.

Note that (NB−1)/(NB−1+ND) is only a little less than NB/(NB+ND). (In the NB=ND=10 example, NB/(NB+ND) is 0.5, and (NB−1)/(NB−1+ND) is 9/19, or 0.47.) To simplify the formula for P_{UNDET}(2), we can approximate (NB−1)/(NB−1+ND) as NB/(NB+ND). This yields a slightly more conservative (higher) probability of not detecting the addition of two votes:

P_{UNDET}(2)=0.5*0.5=0.25.

In general, one may conservatively compute the probability of not detecting any of NF_{A} fraudulent additions as:

P_{UNDET}(NF_{A})=(NB/(NB+ND))**NF_{A},

meaning (NB/(NB+ND)) to the NF_{A}'th power.

The probability of detecting the fraudulent addition of at least one of the NF_{A} votes may also be calculated. As indicated earlier, this is just “one minus the probability of not detecting any of the fraud votes,” or:

P_{DET}(NF_{A})=1−(NB/(NB+ND))**NF_{A}

This can be simplified by expressing both NB and ND in terms of the total number, NR, of actual voters on the roster. If fA represents the fraction of the roster-count that actually voted, then NA=fA*NR is the voter-turnout, and NB=(1−fA)*NR is the number of eligible voters that did not vote. Similarly, fD may be defined such that ND=fD*NR. Then:

$$\begin{matrix}{P}_{DET} ( {NF}_{A} ) = 1 - ( NB / ( NB + ND ) ) ** {NF}_{A} \\ = 1 - ( ( ( 1 - fA ) * NR ) / ( ( 1 - fA ) * NR + fD * NR ) ) ** {NF}_{A} \\ = 1 - ( ( 1 - fA ) / ( 1 - fA + fD ) ) ** {NF}_{A}\end{matrix}$$

This is the probability of detecting at least one of the NF_{A} fraudulently added votes. The only three quantities that affect this probability are: (1) fA, which is the fraction of eligible voters that actually voted in this election; (2) fD, which expresses the number of Category D QA VINs the QA unit requests to be generated, as a multiple of the roster-count; and (3) NF_{A}, the number of added votes one is trying to detect.

As an example, suppose there is a 75% turnout (fA=0.75). Assume the same number of Category D QA VINs are generated as there are eligible voters (fD=1.0). Then for the first few values (1, 2, 3) of NF_{A}:

P_{DET}(1)=1−((1−0.75)/(1−0.75+1.0))**1=1−(0.25/1.25)=1−0.2=0.8

P_{DET}(2)=1−((1−0.75)/(1−0.75+1.0))**2=1−0.2**2=1−0.04=0.96

P_{DET(}3)=1−((1−0.75)/(1−0.75+1.0))**3=0.99

In other words, regardless of the size of the roster, when there is 75% turnout and the same number of Category D VINs as roster-count are generated, the probability of being able to detect even a single added vote is 80%, and rises close to a certainty when three votes are added.

With this method—involving generating some VINs that will never be used to vote, and checking a used-VINs report after the election closes—any error or fraud by the ESP that injects even a single fraudulent vote has a very high likelihood of being detected by the organization, and it becomes a near certainty to detect with only a couple more added votes.

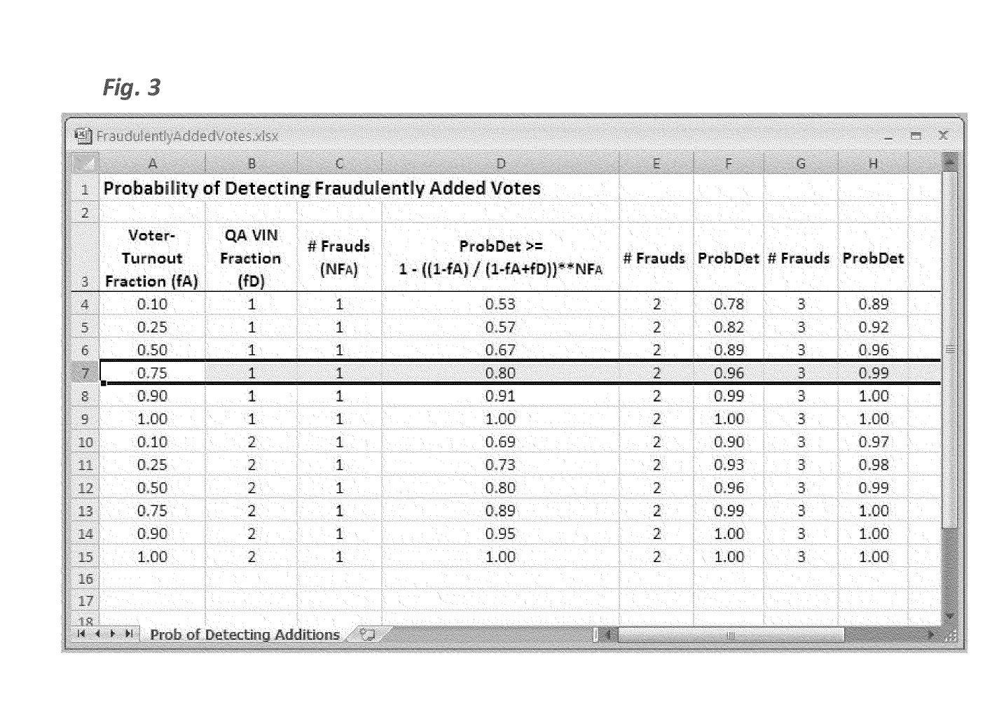

A spreadsheet may be referred to, such as that represented in FIG. 3 to see how varying values of fA, fD, and NF_{A} affect the probability of detecting fraudulently added votes. Based on the organization's comfort-level for the probability of detecting added votes, and on some reasonable expectation of turnout for a given election, an appropriate value for fD can be selected.

To detect removed or deleted votes, some number of excess VINs (Category C) are allocated and will be used by the QA unit to cast QA votes. If the used-VINs report is missing any of these VINs, then fraud by the ESP has been detected. This scheme works because the ESP is unaware of which VINs the organization is using for QA, and which ones have been handed to eligible voters.

The analysis leading to the probability of detecting that a vote has been removed is almost identical to that for detecting added votes, and won't be repeated here. It is sufficient to note that not being detected entails removing only Category A votes; removing any Category C votes will be detected through the used-VINs report.

At the end of the analysis we arrive at:

P_{DET}(NF_{R})=1−(NA/(NA+NC))**NF_{R}

where NF_{R} is the number of fraudulently removed votes. If we express NC as a fraction (or multiple) fC of the roster-count, NR, this conveniently reduces to:

$$\begin{matrix}{P}_{DET} ( {NF}_{R} ) = 1 - ( NA / ( NA + NC ) ) ** {NF}_{R} \\ = 1 - ( ( fA * NR ) / ( fA * NR + fC * NR ) ) ** {NF}_{R} \\ = 1 - ( fA / ( fA + fC ) ) ** {NF}_{R}\end{matrix}$$

To put some numbers on it, suppose there is a 75% turnout (fA=0.75). Assume the organization requests that the same number of Category C QA VINs be generated as there are eligible voters (fC=1.0). Then for the first few values (1, 2, 3) of NF_{R} we see:

P_{DET}(1)=1−(0.75/(0.75+1.0))**1=1−(0.75/1.75)=1−0.43=0.57

P_{DET}(2)=1−(0.75/(0.75+1.0))**2=1−0.43**2=1−0.18=0.82

P_{DET}(3)=1−(0.75/(0.75+1.0))**3=0.92

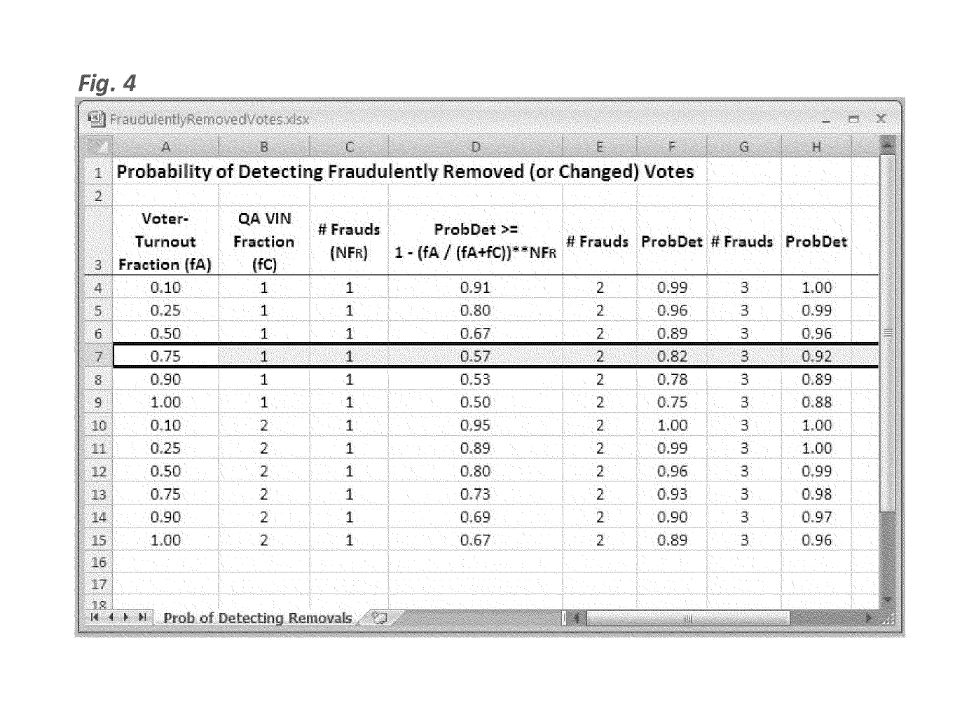

In other words, regardless of the size of the roster, when there is 75% turnout and we generate the same number of Category C VINs as roster-count, the probability of being able to detect even a single removed vote is 57%, and rises close to a certainty when three votes are removed. FIG. 4 represent a spreadsheet that illustrate how varying values of fA, fC, and NF_{R} may affect the probability of detecting fraudulently removed votes.

Detecting changed votes can be treated exactly the same as detecting removed votes, except that the QA unit preferably uses a software tool, such as interface 44, to retrieve from the ESP the content of the QA votes that were cast. The QA unit may then compare them to what vote contents were used when casting the votes using the known Category C VINs. Preferably the ESP builds and make available such a tool to the QA unit. Such a tool may also be operable for the QA unit to both detect removals and changed votes at once.

Because detecting removed votes and changed votes both rely on casting QA votes using Category C VINs, the same analysis and spreadsheet developed for detecting removed votes can be used for changed votes, yielding the same or similar formulas and probabilities. See FIG. 4.

### Practicality of Injecting QA Votes

Like votes cast by actual voters, such as employees in a union, QA votes would be cast by telephone or Internet. A practical issue associated with casting QA votes is how to cast them so that the ESP is unable distinguish them from voters' votes.

For voting by telephone, the QA unit and/or the ESP may have its telephone carrier configure their equipment to not deliver the caller-ID on incoming phone calls to the voting system. The effect would be that votes cast by telephone are anonymous, so there is no opportunity for a defrauding ESP to trace the call back to a named individual, and thereby determine whether it is a QA vote or not.

For voting by Internet, the origin of the vote should also be obscured. Source addresses typically are in the form of “IP addresses.” Casting one hundred votes from a single computer would normally give rise to very similar or even identical IP addresses, so an ESP attempting to defraud the ballot might avoid changing or removing votes sent from an unusually high-volume IP source address. A brute-force method to avoid casting a large number of votes from a single IP address is to parcel out responsibility for casting votes to a number of human agents of the organization, where the computers used to vote are remotely distributed. However, any suitable means, such as one or more Anonymous Proxy Servers may be used.

In cases where the number of QA votes to be cast is large, automated schemes are desirable. For voting by telephone, an automated telephony system can be programmed to call the voting system to cast QA votes at times and with ballot-selections known only to the QA unit.

One way to automate casting votes by Internet is to outfit many remotely distributed computers with software to automatically cast QA votes at times and with ballot-selections supplied by the organization. Each remote computer could periodically check with a centralized computer whether it's time for it to cast a QA vote on behalf of the QA unit.

Accordingly, while embodiments of election methods and systems have been particularly shown and described with reference to the foregoing disclosure, many variations may be made therein. Various combinations and sub-combinations of features, functions, elements and/or properties may be used. Such variations, whether they are directed to different combinations or directed to the same combinations, whether different, broader, narrower or equal in scope, are also regarded as included within the subject matter of the present disclosure. The foregoing embodiments are illustrative, and no single feature or element is essential to all possible combinations that may be claimed in this or later applications. The claims, accordingly, define selected inventions disclosed in the foregoing disclosure. Where the claims recite “a” or “a first” element or the equivalent thereof, such claims include one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

What is claimed is:

1. A method for a quality assurance (QA) unit to evaluate at least one quality of an election conducted by an election service provider (ESP) for an organization, the election providing for voting by a quantity of voters associated with the organization and for assuring the at least one quality of the election to a confidence level specified by the organization, wherein the ESP operates a computer system for carrying out the election, the computer system connected to an electronic communication link and configured to receive a plurality of votes from the quality assurance unit and from the voters via the electronic communication link during a voting period, each vote comprising a vote-identification number (VIN) and a vote content, the method comprising the steps of:
receiving, by a QA computer controlled and operated by the QA unit, the voter quantity and the at least one confidence level for the at least one election quality provided by the organization;
determining by the QA computer an election quantity that is greater than the voter quantity;
requesting the election quantity of VINs from the ESP computer system via the electronic communication link;
receiving by the QA computer the election quantity of VINs from the ESP computer system via the electronic communication link;
allocating as QA VINS by the QA computer a QA quantity of VINS from the election quantity of VINs and providing to the organization the voter quantity of VINs;
voting by the QA computer at least a portion of the QA VINs during the voting period via the electronic communication link;
receiving by the QA computer from the ESP computer system a list of all VINs in the plurality of received votes; and
comparing by the QA computer the VINs in the plurality of received votes to the QA VINs voted during the voting period; and
determining by the QA computer the at least one quality of the election and reporting the at least one quality of the election to the organization.

2. The method of claim 1 further including a step of allocating the QA quantity of VINs by the QA computer into a deletion-detection quantity of VINs and an insertion-detection quantity of VINs.

3. The method of claim 2 wherein the step of voting the portion of the QA VINs includes voting the deletion-detection quantity of VINs and wherein the step of reporting the at least one quality of the election to the organization includes reporting whether any votes of the QA VINs were deleted by the ESP.

4. The method of claim 2 wherein the insertion-detection quantity of VINs are not voted during the voting period and wherein the step of reporting the at least one quality of the election to the organization includes reporting whether any votes of the QA VINs were inserted by the ESP.

5. The method of claim 1 further including a step, after the voting period, of providing by the QA computer to the ESP computer system a list of the QA VINs voted during the voting period and receiving by the QA computer from the ESP computer system the vote content for each voted QA VIN, and wherein the step of reporting the at least one quality of the election to the organization includes reporting whether any vote content was changed by the ESP.

6. The method of claim 1 wherein the QA computer determines the election quantity of VINs by applying a quality factor to the quantity of voters, wherein the quality factor is calculated from the at least one confidence level.

7. The method of claim 6 further comprising a step of providing a spreadsheet for calculation of the quality factor from the at least one confidence level.

8. The method of claim 1 further comprising a step of reporting the at least one quality of the election to an entity independent of the organization for whom the election was conducted.

9. The method of claim 1 wherein the step of voting the QA votes during the voting period includes preventing the ESP from distinguishing the QA votes from votes received from voters.

10. A method for a quality assurance (QA) unit to evaluate an election conducted by an election service provider (ESP) for an organization, wherein the election provides for voting by a quantity of voters associated with the organization and for evaluating a likelihood that no votes have been deleted or inserted by the ESP, wherein the ESP operates a computer system for carrying out the election, the computer system connected to an electronic communication link and configured to receive a plurality of votes from the QA unit and from the voters via the electronic communication link during a voting period, each vote comprising a vote-identification number (VIN) and a vote content, the method comprising the steps of:
receiving, by a QA computer controlled and operated by the QA unit, the voter quantity provided by the organization;
determining by the QA computer an election quantity that is greater than the voter quantity;
requesting the election quantity of VINs from the ESP computer system via the electronic communication link;
receiving by the QA computer the election quantity of VINs from the ESP computer system via the electronic communication link;
allocating as QA VINS by the QA computer a QA quantity of VINS from the election quantity of VINs and providing to the organization the voter quantity of VINs;
allocating the QA VINs into a to-be-voted quantity of QA VINs and a not-to-be-voted quantity of QA VINs;
voting by the QA computer the to-be-voted QA VINs, during the voting period via the electronic communication link;
receiving by the QA computer from the ESP computer system, after the voting period, a list of all VINs in the plurality of received votes;
comparing by the QA computer the list of VINs in the plurality of received votes to the voted QA VINs and to the not-to-be-voted VINs; and
determining by the QA computer the likelihood that no votes in the plurality of votes received from the voters were deleted or inserted by the ESP.

11. The method of claim 10 further arranged for evaluating a likelihood that no votes have been changed by the ESP and further wherein the step for voting the to-be-voted QA VINs includes maintaining by the QA computer a record of the vote content for each to-be-voted QA VIN; and further comprising the steps of:
providing by the QA computer to the ESP computer system, after the voting period, the voted QA VINs and receiving by the QA computer from the ESP computer system the vote content for each voted QA VIN and comparing to the vote content for each to-be-voted QA VIN; and
determining the likelihood that no votes in the plurality of votes received from the voters were changed by the ESP.

12. An election evaluation system for evaluating at least one quality of an election conducted by an election service provider (ESP) for an organization, wherein the ESP operates a computer system for carrying out the election, the ESP computer system programmed to provide in the election for voting during a voting period by a quantity of voters associated with the organization, the voters transmitting votes via an electronic communication link to the ESP computer system, each vote comprising a vote-identification number (VIN) and a vote content, the election evaluation system configured to assure the at least one quality of the election to a confidence level specified by the organization, the election evaluation system comprising:
a quality assurance (QA) computer;
a coupler on the QA computer for interfacing via the electronic communication link with the ESP;
wherein the QA computer is programmed for receiving from the organization the voter quantity and the at least one confidence level for the at least one election quality; for determining an election quantity that is greater than the voter quantity; and for obtaining the election quantity of VINs from the ESP computer system via the electronic communication link; and
further wherein the QA computer is programmed for allocating as QA VINS a QA quantity of VINS from the election quantity of VINs and providing to the organization the voter quantity of VINs; for voting at least a portion of the QA VINs during the voting period via the electronic communication link; and for receiving from the ESP computer system a list of all VINs in the plurality of received votes; and
further wherein the QA computer is programmed for comparing the VINs in the plurality of received votes to the QA VINs voted during the voting period; and for determining the at least one quality of the election and reporting the at least one quality of the election to the organization.

13. The system of claim 12 further wherein the QA computer is programmed for allocating the QA quantity of VINs into a deletion-detection quantity of VINs and an insertion-detection quantity of VINs; and for voting the deletion-detection quantity of VINs and not voting the insertion-detection quantity of VINs.

14. The system of claim 13 further wherein the QA computer is programmed for reporting whether any votes of the QA VINs were deleted or inserted by the ESP computer system.

15. The system of claim 12 further wherein the QA computer is programmed for providing to the ESP computer system, after the voting period, a list of the QA VINs voted during the voting period and for receiving from the ESP computer system the vote content for each voted QA VIN, and for reporting whether any vote content was changed by the ESP computer system.

16. The system of claim 12 further wherein the QA computer is programmed for determining the election quantity of VINs by applying a quality factor to the quantity of voters, wherein the quality factor is calculated from the at least one confidence level.

17. At least a first storage medium readable by at least a first processor, having embodied therein a first program of commands executable by the first processor, wherein the first processor is operable within a quality assurance (QA) computer, the first program operable for evaluating at least one quality of an election conducted by an election service provider (ESP) for an organization, wherein the ESP operates a computer system for carrying out the election, the ESP computer system programmed to provide in the election for voting during a voting period by a quantity of voters associated with the organization, the voters transmitting votes via an electronic communication link to the ESP computer system, each vote comprising a vote-identification number (VIN) and a vote content, the QA computer coupled to the ESP computer system via the electronic link and configured to assure the at least one quality of the election to a confidence level specified by the organization, the first program including one or more modules:
for receiving from the organization the voter quantity and the at least one confidence level for the at least one election quality; for determining an election quantity that is greater than the voter quantity; and for obtaining the election quantity of VINs from the ESP computer system via the electronic communication link;
for allocating as QA VINS a QA quantity of VINS from the election quantity of VINs and providing to the organization the voter quantity of VINs; for voting at least a portion of the QA VINs during the voting period via the electronic communication link;
for receiving from the ESP computer system a list of all VINs in the plurality of received votes; and
for comparing the VINs in the plurality of received votes to the QA VINs voted during the voting period; and for determining the at least one quality of the election and reporting the at least one quality of the election to the organization.

18. The storage medium of claim 17 wherein the first program further includes one or more modules for determining the election quantity of VINs by applying a quality factor to the quantity of voters, wherein the quality factor is calculated from the at least one confidence level.

19. The storage medium of claim 18 wherein the first program further includes one or more modules for analyzing a spreadsheet for calculation of the quality factor from the at least one confidence level.

20. The storage medium of claim 17 wherein the first program further includes one or modules for providing by the QA computer to the ESP computer system, after the voting period, the voted QA VINs and for receiving by the QA computer from the ESP computer system the vote content for each voted QA VIN and comparing to the vote content for each to-be-voted QA VIN; and for reporting any discrepancies.
